(19) United States
(12) Patent Application Publication
(10) Pub. No.: US 2002/0112918 A1
(43) Pub. Date: Aug. 22, 2002

(54) Moveable step ladder

(76) Inventor: Anton Frketic, Winnipeg (CA)

Correspondence Address: ADE & COMPANY, 1700-360 MAIN STREET, WINNIPEG, MB, R3C3Z3, CA

(21) Appl. No.: 10/056,065

(22) Filed: Jan. 28, 2002

Related U.S. Application Data
(60) Provisional application No. 60/264,301, filed on Jan. 29, 2001.

(51) Int. Cl. E06C 1/00

(52) U.S. Cl. 182/16

(57) ABSTRACT

A step ladder comprising an upright frame and a plurality of wheels on the frame arranged to engage a ground surface. A drive wheel assembly is arranged to drive at least one of the wheels for moving the ladder and being arranged to be controlled by a user positioned on the ladder. A steering wheel assembly for steering at least another one of the wheels and being arranged to be controlled by a user positioned on the ladder. A pulley arrangement of the drive wheel assembly extending from a top portion of the ladder within an interior of the frame to a driven wheel and a drive mechanism coupled to the pulley arrangement at the top portion of the ladder for driving the pulley arrangement.

### FIELD OF THE INVENTION

The present invention relates to a moveable step ladder, more particularly a step ladder that is movably operated by a person on the ladder.

### BACKGROUND

There are many variations of step ladders known. A common problem that may confront a user using a step ladder is regularly having to step down from the ladder to position the ladder in a different position. Many step ladders have wheels which allow the ladder to be moved across the ground but the user may still have to step off the ladder to do this. Some examples of ladders that have arrangements for moving across the ground are shown in U.S. Pat. Nos. 4,911,263 (Kuperman), 5,653,305 (Duke) and 4,899,847 (Lufkin).

### SUMMARY

According to the present invention there is provided a step ladder comprising:

an upright frame;

a plurality of wheels on the frame arranged to engage a ground surface;

a drive wheel assembly for driving at least one of the wheels for moving the ladder and being arranged to be controlled by a user positioned on the ladder;

a steering wheel assembly for steering at least another one of the wheels and being arranged to be controlled by a user positioned on the ladder;

a pulley arrangement of the drive wheel assembly extending from a top portion of the ladder within an interior of the frame to a driven wheel; and,

a drive mechanism coupled to the pulley arrangement at the top

### DETAILED DESCRIPTION

A movable step ladder, generally indicated at 1 has an upright frame 3 made of aluminium or metal or any other suitable material which is arranged to support a persons weight. The frame has two pivotally connected ladder sections 5A and 5B which are pivotally connected at a top end 7 and extend radially outwards therefrom. The pivotal movement of the ladder sections allows the ladder sections to open and close relative to each other, similar to a conventional step ladder. Each ladder section has a pair of parallel side rails 9 which extend radially outwards from the pivot connection. The side rails are spaced apart and have a plurality of steps 11 connecting the respective side rails to another respective side rail. The steps are spaced along the side rails such that a person can manoeuvre themselves upwards or downwards on the ladder. A brace 13 connects each ladder portion and is connected to a respective side rail on the ladder portions which prohibits the ladder portions from rotating to far from the next. The present invention is similar to a conventional step ladder in that it provides the same general uses of a common step ladder.

Each side rail has a hollow interior 15 such that a drive mechanism 17 and a steering mechanism 19 can be arranged therein on respective side rails on a respective ladder portion. On a first ladder portion, the drive mechanism is located within each side rail. The drive mechanism has a drive sprocket 21 located at a top end of the side rails, a sprocket is located within each of the side rails. A drive handle 25 is arranged to rotate the drive sprocket which extends from one of the sprockets to the next thereby driving each sprocket with equal rotations. The drive mechanism is located within the step of the ladder such that the drive mechanism is protected within the frame of the ladder. A pair of chains 27, each chain being mounted on a respective sprocket extend downwardly within the hollow interior of a can also steer the ladder in a direction desired by the user. The steering mechanism has a pair of steering rods 45, each one of the steering rods being located within a respective interior portion of the side rails which extends from a top end of the side rails to a bottom end thereof. The steering rod is rotated by a steering handle 47 located at a top end of the steering rod such that the handle can be engaged by a user on the ladder. Rotation of the steering rod thereby rotates the steering wheels such that the user can control the direction of the ladder while remaining positioned on the ladder. The steering handle is arranged to rotate a connector rod 49 such that rotation of the handle simultaneously rotates each steering rod within the interior of each rail.

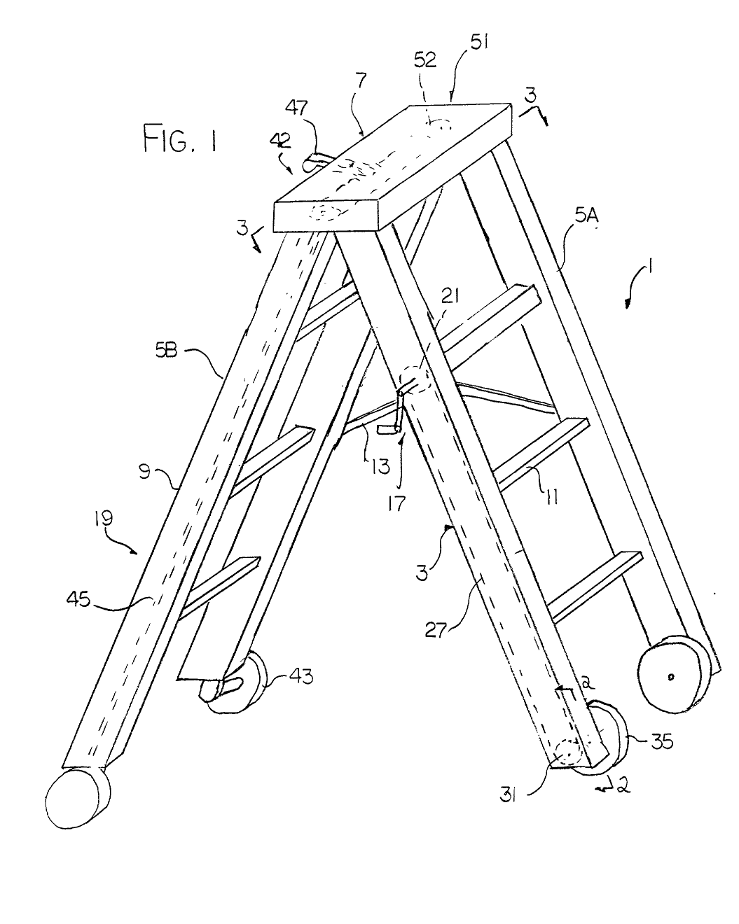

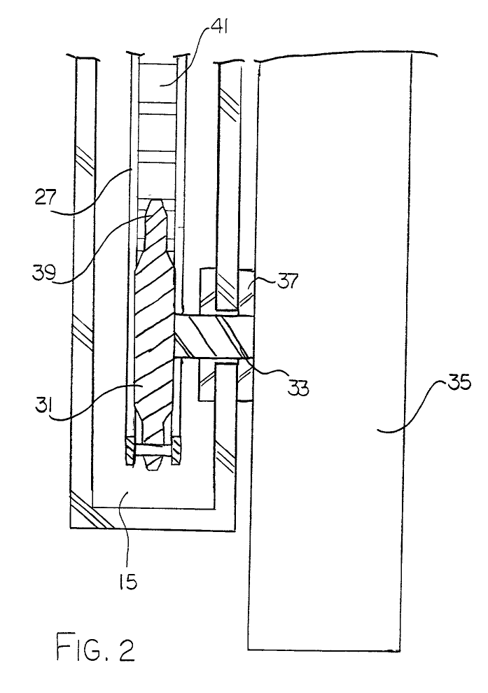

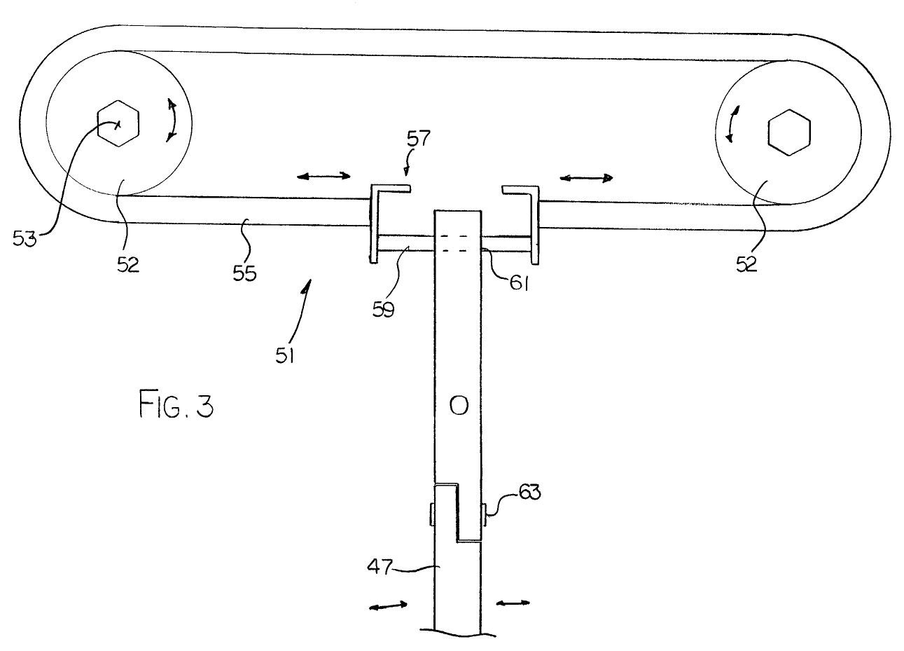

The steering rod is rotated by a chain and sprocket assembly 51 located within the top end of the ladder, as best shown in FIG. 3. A pair of sprockets 52 are spaced apart within the top end such that an axis 53 of each sprocket extend parallel within each respective side rail. Connected to and extending from each sprocket is the respective steering rod. A chain 55 extends and wraps around each sprocket which is arranged to rotate each sprocket simultaneously about the axis 53. A bracket 57 is located between the sprockets and is arranged to separate one length of the chain being connected to the chain at respective sides for receiving the handle. The handle is mounted to the bracket on a horizontal connecting rod 59 such that the handle is pivotally connected thereto. A pivot mount 61, mounts the handle to the top portion of the ladder providing a lever action to the handle. Side to side horizontal movement of the handle pushes the chain in a relative direction which rotates the sprockets thereby providing steering to the wheels. The handle has a horizontal axis connection 63 which provides an end 65 of the handle which extends out of the top end with vertical movement, as best shown in FIG. 3.

In an alternative embodiment, not shown, the drive chain extends through separate tubes. The separate tubes replace the rail of the ladder for different styles of ladders, such that the sprockets are located at respective ends of each tube.

While one embodiment of the present invention has been described in the foregoing, it is to be understood that other embodiments are possible within the scope of the invention. The invention is to be considered limited solely by the scope of the appended claims.

1. A step ladder comprising:
an upright frame;
a plurality of wheels on the frame arranged to engage a ground surface;
a drive wheel assembly arranged to drive at least one of the wheels for moving the ladder and being arranged to be controlled by a user positioned on the ladder;
a steering wheel assembly arranged to steer at least another one of the wheels and being arranged to be controlled by a user positioned on the ladder;
a pulley arrangement of the drive wheel assembly extending from a top portion of the ladder within an interior of the frame to a driven wheel; and,
a drive mechanism coupled to the pulley arrangement at the top portion of the ladder arranged to drive the pulley arrangement.

2. The ladder according to claim I wherein the drive mechanism is located within the frame of the ladder.

3. The ladder according to claim 1 wherein the drive mechanism has at least two sprockets, one of the sprockets being located within the frame is driven by a handle which is external of the frame, a chain is connected to each of the sprockets such that rotation of the handle drives one of the sprockets and wherein another one of the sprockets is coupled to a wheel on the frame providing forwards and rearwards movement of the ladder across a ground surface.

4. The ladder according to claim I wherein the steering wheel assembly comprises a pair of steering sprockets located within the frame, each one of the sprockets is connected to one of a pair of steering rods which extend from the respective sprocket to a respective wheel.

5. The ladder according to claim 4 wherein the steering sprockets are rotated by a steering handle with is pivotally connected to a steering chain which wraps around the steering sprockets such that pivotal movement of the steering handle simultaneously rotates the steering sprockets thereby rotating the steering wheels.

6. The ladder according to claim 5 wherein the steering handle extends from the frame for access by the user.
